(19) United States
(12) Patent Application Publication
(10) Pub. No.: US 2015/0321147 A1
(43) Pub. Date: Nov. 12, 2015

(54) STACKED TWO-DIMENSIONAL MATERIALS AND METHODS FOR PRODUCING STRUCTURES INCORPORATING SAME

(71) Applicant: LOCKHEED MARTIN CORPORATION, Bethesda, MD (US)

(72) Inventors: Shawn P. FLEMING, Lumberton, NJ (US); Peter V. BEDWORTH, Los Gatos, CA (US); David F. CASEY, JR., Voorhees, NJ (US); Scott E. HEISE, San Jose, CA (US); Matthew M. KAPELANCZYK, Baltimore, MD (US); Steven W. SINTON, Palo Alto, CA (US); Randall M. STOLTENBERG, Palo Alto, CA (US); Jacob L. SWETT, Mountain View, CA (US); David B. TUROWSKI, Palmyra, NJ (US); Han LIU, Lutherville-Timonium, MD (US)

(21) Appl. No.: 14/707,808

(22) Filed: May 8, 2015

Related U.S. Application Data
(60) Provisional application No. 61/990,204, filed on May 8, 2014.
(60) Provisional application No. 61/990,561, filed on May 8, 2014.

(51) Int. Cl. B01D 63/08; B01D 61/00; B32B 37/00; B01D 61/14; B32B 37/18; B01D 65/00; B01D 61/02

(52) U.S. Cl. CPC B01D 63/082; B01D 65/003; B01D 63/081; B01D 61/002; B01D 61/025; B01D 61/027; B01D 61/145; B01D 61/147; B32B 37/18; B32B 37/0084

(57) ABSTRACT

Structures comprising a first sheet of perforated two-dimensional material and a first plurality of spacer elements disposed between a surface of the first sheet of perforated two-dimensional material and at least one of a surface of a structural substrate and a surface of a second sheet of perforated two-dimensional material are disclosed, as well as related methods. The structures may further comprise a structural substrate, a second plurality of spacer elements, additional sheets of perforated two-dimensional material in direct contact with the first and/or said second sheet of perforated two-dimensional material and/or relief features in the surface of the structural substrate.

### CROSS-REFERENCE TO RELATED APPLICATIONS

This application claims the benefit of priority under 35 U.S.C. §119 from U.S. Provisional Patent Application Nos. 61/990,204 and 61/990,561, both filed May 8, 2014, which are incorporated herein by reference in their entireties.

### STATEMENT REGARDING FEDERALLY SPONSORED RESEARCH OR DEVELOPMENT

Not applicable.

### FIELD

The present disclosure generally relates to graphene, graphene-based materials and other two-dimensional materials. More specifically, the present disclosure relates to structures having stacked perforated graphene, graphene-based or other two-dimensional materials and methods for producing the stacked structures.

### BACKGROUND

Graphene represents an atomically thin layer of carbon in which the carbon atoms reside at regular lattice positions. In many applications, it can be desirable to place a plurality of holes, apertures or like perforations in the graphene basal plane. Such holes will also be equivalently referred to herein as pores. Other two-dimensional materials can contain similar perforations and be used in applications in a like manner to graphene. The terms “perforated graphene” or “perforated two-dimensional material” will be used herein to denote a sheet with holes in its basal plane, regardless of how the holes have been introduced. Such holes can be present in both single-layer and few-layer graphene (e.g., less than 10 graphene layers but more than 1), as well as in multiple sheets of single-layer or few-layer graphene stacked upon one another.

Although graphene and other two-dimensional materials have unprecedented mechanical strength, it is still desirable to provide mechanical support to the two-dimensional materials to support many common applications, such as filtration applications. In many instances, graphene and other two-dimensional materials can be placed upon a smooth structural substrate. The structural substrate can lessen the influence of high pressures on the graphene by dispersing a load placed thereon. However, due to the atomic thinness of graphene, damage to the graphene can occur when transferring the graphene to the substrate. The damage can occur in the form of the undesirable generation of tears or other defects in the graphene or other two-dimensional materials. One way in which graphene damage can be decreased, particularly under operating conditions, is by utilizing a structural substrate that has a very smooth surface topology/morphology. However, smooth structural substrates that maintain a high degree of porosity are rare, and misalignment between perforations within a sheet of two-dimensional material and pores within a substrate decrease overall permeability.

In view of the foregoing, techniques that increase the permeability of structures comprising two-dimensional materials and porous supporting substrates would be of considerable benefit. The present disclosure satisfies this need and provides related advantages as well.

### SUMMARY

The structures and methods disclosed herein may be used for filtration and separation applications to selectively separate desired and unwanted components of a medium, for example, by reverse osmosis, nanofiltration, ultrafiltration, microfiltration, forward osmosis, or pervaporative separation. The disclosed structures advantageously utilize perforated, atomically thin, two-dimensional materials as active filtration or separation membranes that provide high permeability, strength and resistance to fouling. In addition, the structures are formed as stacked multilayer configurations that provide a number of advantages over simple, non-stacked configurations. For example, in some of the stacked multilayer configurations, two or more sheets of perforated two-dimensional materials having randomly distributed selective and non-selective pores overlap such that surfaces of the sheets are in direct contact with one another. This configuration improves selectivity of the structure by reducing or eliminating the impact of non-selective pores, which may be covered or “patched” by the adjacent sheet. In some embodiments, a layer of spacer elements is provided between single or stacked two-dimensional sheets or between a single or stacked two-dimensional sheet and a supporting substrate, thereby providing a selective or non-selective flow path through the layer of spacer elements. This configuration increases permeability of the structures by enabling lateral flow of the medium. For some applications, the gain in permeability realized by the present structures allows supporting substrates with lower porosity/permeability than would otherwise be required for a particular application to be used. Further, the presence of spacer elements on a surface of a supporting substrate can mitigate substrate surface roughness such that substrates that would otherwise be too rough to receive a two-dimensional material may be used. Thus, the present structures may provide improved selectivity and/or expand the scope of suitable substrate materials in filter applications.

In an aspect, a structure comprises a first sheet of perforated two-dimensional material and a first plurality of spacer elements disposed between a surface of the first sheet of perforated two-dimensional material and at least one of a surface of a structural substrate and a surface of a second sheet of perforated two-dimensional material.

In some embodiments where the first plurality of spacer elements is disposed between the surface of the first sheet of perforated two-dimensional material and the surface of the second sheet of perforated two-dimensional material, the structure further comprises a structural substrate disposed on an alternate surface of the first or second sheet of perforated two-dimensional material. In some embodiments, the first plurality of spacer elements is disposed between the surface of the first sheet of perforated two-dimensional material and the surface of the second sheet of perforated two-dimensional material and a second plurality of spacer elements is disposed between the surface of the structural substrate and an alternate surface of the first or second sheet of perforated two-dimensional material. In some embodiments, any one of the previously described structures may include one or more additional sheets of perforated two-dimensional material in direct contact with said first and/or said second sheet of perforated two-dimensional material.

Suitable perforated two dimensional materials for use in the present structures and methods include but are not limited to those derived from carbon sources, as well as materials based on boron nitride, silicon, germanium, and transition metals combined with chalcogens, such as oxygen, sulfur, selenium, and tellurium. In an embodiment, the first or second sheet of perforated two-dimensional material comprises a graphene or graphene-based film, a transition metal dichalcogenide, α-boron nitride, silicene, germanene, germanane, MXene (e.g., M₂X, M₃X₂, M₄X₃, where M is an early transition metal such as Sc, Ti, V, Zr, Cr, Nb, Mo, Hf and Ta and X is carbon and/or nitrogen) or a combination thereof. (See, Xu et al. (2013) “Graphene-like Two-Dimensional Materials”, Chemical Reviews 113: 3766-3798; Zhao et al. (2014) “Two-Dimensional Material Membranes”, Small, 10(22), 4521-4542; Butler et al. (2013) “Progress, Challenges, and Opportunities in Two-Dimensional Materials Beyond Graphene”, Materials Review, 7(4) 2898-2926; Chhowalla et al. (2013) “The chemistry of two-dimensional layered transition metal dichalcogenide nanosheets”, Nature Chemistry, vol. 5, 263-275; and Koski and Cui (2013) “The New Skinny in Two-Dimensional Nanomaterials”, ACS Nano, 7(5) 3739-3743, which are incorporated herein by reference as disclosing two-dimensional materials.) In an embodiment, the first or second sheet of perforated two-dimensional material has an average pore size less than or equal to 400 nm, or less than or equal to 200 nm, or less than or equal to 100 nm. In an embodiment, the first or second sheet of perforated two-dimensional material has an average pore size selected from a range of 4000 angstroms to 3 angstroms, or 2000 angstroms to 1000 angstroms, or 1000 angstroms to 500 angstroms, or 500 angstroms to 100 angstroms, or 100 angstroms to 5 angstroms, or 25 angstroms to 5 angstroms, or 5 angstroms to 3 angstroms. In an embodiment, the pore size is selected based on the molecule(s) to be separated. In an embodiment, the first sheet of two-dimensional material has a first average pore size and the second sheet of two-dimensional material has a second average pore size where the first average pore size is different from the second average pore size. In an embodiment, the first sheet with a smaller average pore size is upstream (closer to the feed) from the second sheet with the larger average pore size. In an embodiment, the first or second sheet of perforated two dimensional material comprises randomly distributed pores. In an embodiment, the pores of the first or second sheet of perforated two-dimensional material are chemically functionalized at peripheries of the pores.

In some embodiments, structures disclosed herein comprise spacer elements that facilitate lateral flow between two-dimensional sheets and/or between a two-dimensional sheet and a supporting substrate. For example, spacer elements may be particulate or discrete units that are distributed on a surface as a non-contiguous mass. In an embodiment, spacer elements are randomly oriented and positioned.

In some embodiments, a layer of the spacer elements has a thickness selected from a range of 5 angstroms to 10000 angstroms, or 1000 angstroms to 5000 angstroms, or 100 angstroms to 500 angstroms, or 5 angstroms to 100 angstroms, or 5 angstroms to 25 angstroms, or 4 angstroms to 8 angstroms. In an embodiment, a layer of the spacer elements has a substantially uniform thickness. For example, a uniform distribution of spacer elements may be achieved by a solution technique, such as spray coating or spin coating. In an embodiment, a layer of the spacer elements has a non-uniform thickness. In an embodiment, the spacer elements have average dimensions (e.g., average heights, average widths, average lengths or average diameters) from 0.5 nm to 200 nm, or 0.5 nm to 400 nm, or 10 nm to 500 nm, or 50 nm to 750 nm, or 100 nm to 1000 nm.

In an embodiment, the spacer elements are separated from each other such that the adjacent sheets are completely separated from one another. In an embodiment, the spacing between the spacer elements is such that the two-dimensional sheet on top of the spacer elements drapes over the spacer elements. In an embodiment, spacer elements cover approximately 1-30% of the surface of an adjacent surface. For example, when the spacer elements cover 1-10% of the surface of an adjacent surface a top sheet may drape over the spacer elements potentially causing contact between the adjacent sheets. In another example, when the spacer elements cover 20-30% of the surface of an adjacent surface a top sheet is completely separated from an adjacent sheet. In an embodiment, an average density of the spacer elements is from 2000 per μm² to 1 per μm². One or more sealing elements and/or filter housing walls may be provided at the edges of the sheets to restrict outflow from the edges of the sheets.

In an embodiment, the spacer elements adhere to the first and/or second sheet of perforated two-dimensional material. For example, carbon-based spacer elements may interact with a two-dimensional sheet of graphene or graphene-based material through pi-pi electron interactions or van der Waals interactions. Carbon-based spacer elements capable of this type of interaction include, but are not limited to, carbon nanotubes and carbon nanostructures. Chemical moieties capable of this type of interaction include, but are not limited to, polyaromatic hydrocarbons and pendant groups with condensed aromatic rings. As a further example, the spacer element may interact with the two-dimensional sheet via direct covalent bonding. Alternatively, a spacer element may comprise chemical moieties on a surface thereof for undergoing a chemical reaction with a supporting substrate, a two-dimensional material, or both, where the chemical reaction produces covalent bonds.

Suitable spacer elements include but are not limited to nanoparticles, nanotubes, nanofibers, nanorods, nanostructures, nanohorns, fullernes or combinations thereof. In an embodiment, the spacer elements are selected from the group consisting of single walled carbon nanotubes, multiwalled carbon nanotubes, carbon nanostructures, fullerenes, carbon nanohorns and combinations thereof. In a further embodiment, the particles are metal nanoparticles. The metal nanoparticles may be gold, platinum or metal nanoparticles that form bonds with carbon. In a further embodiment, the spacer elements are partial layers of two-dimensional material. In embodiments, at least a portion of a surface of the spacer element is functionalized to produce a hydrophobic or hydrophilic surface. In further embodiments, at least a portion of the surface of the spacer element is functionalized with polar or non-polar moieties. Polar groups can include neutral or charged groups. Polar groups include among others halides (e.g., —F, —Cl), hydroxyl (—OH), amino (—NH₂), ammonium (—NH₄⁺), carbonyl, carboxyl and carboxylate (—CO—, —COOH, —COO⁻), nitro (—NO₂), sulfonic acid and sulfonate (—SO₃H, —SO₃), hydrocarbons substituted with one or more polar groups (haloalkyl, hydroxyalkyl, nitroalkyl, haloaryl, hyroxyaryl, nitroaryl, etc), polymers carrying polar groups, and polyalkyeneglycol. Non-polar groups include among others unsubstituted aliphatic and aryl hydrocarbons (e.g., alkyl, alkenyl, and aryl groups). Suitable functional groups include, but are not limited to charged and uncharged polar groups and non-polar groups

In an embodiment, a layer of the spacer elements has an average surface roughness less than or equal to 50 nm, or less than 35 nm, or less than 25 nm.

In an embodiment, the spacing between adjacent sheets is comparable to the average pore size of one of the sheets. In a further embodiment, the spacing between adjacent sheets is smaller than the average pore size of one of the sheets. In a further embodiment, the spacing between adjacent sheets is less than half the smaller of the average pore size of the two adjacent sheets. In a further embodiment, the spacing between adjacent sheets is greater than the larger of the average pore size of the two sheets. For example, the spacing between adjacent sheets may be 5-10 times, 10 to 50 times, or 50 to 100 times the larger of the average pore sizes of the adjacent sheets.

In some embodiments, a structure may include a structural substrate, such as a structural substrate comprising a porous polymer or a porous ceramic. Suitable polymers for a porous or permeable supporting substrate are not believed to be particularly limited and can include, for example, polysulfones, polyethersulfones (PES), polyvinylidine fluoride (PVDF), polypropylene, cellulose acetate, polyethylene, polycarbonate, fluorocarbon polymers such as polytetrafluoroethylene, and mixtures and co-polymers and block co-polymers thereof. For some embodiments, the structural substrate has a thickness less than or equal to 500 nm, or less than or equal to 200 nm. Typically, the structural substrate has a thickness between 1 nm and 500 nm, or 20 nm and 200 nm. In an embodiment, the structural substrate has a porosity greater than or equal to 15%, or greater than or equal to 25%. In some embodiments, the structural substrate has a porosity between 3% and 75%, or 5% and 75%, or 3% and 50%, or 3% and 30%, or 3% and 15%, or 3% to 10%, or 3% to 6%. The porosity may be in terms of volume percent (vol %) or area percent at a surface (area %). In some embodiments, the pores in the first or second sheet of perforated two-dimensional material are at least 10-fold smaller than pores in the structural substrate.

In an aspect, a method for forming a structure comprises disposing a first plurality of spacer elements between a first sheet of perforated two-dimensional material and at least one of a surface of a structural substrate and a surface of a second sheet of perforated two-dimensional material. Alternately, spacers are placed on a first perforated sheet, a second sheet is applied on the spacers and the second sheet is then perforated.

In an embodiment where the first plurality of spacer elements is disposed between the surface of the first sheet of perforated two-dimensional material and the surface of the second sheet of perforated two-dimensional material, the method further comprises providing a structural substrate on an alternate surface of the first or second sheet of perforated two-dimensional material.

In another embodiment where the first plurality of spacer elements is disposed between the surface of the first sheet of perforated two-dimensional material and the surface of the second sheet of perforated two-dimensional material, the method further comprises providing a second plurality of spacer elements on an alternate surface of the first or second sheet of perforated two-dimensional material and providing a structural substrate on the second plurality of spacer elements.

In any of the preceding methods, the two-dimensional material may be perforated after the structure is formed.

In an embodiment, the spacer elements are applied to the structural substrate and the first or second sheet of perforated two-dimensional material is then applied to the spacer elements. In an alternate embodiment, the spacer elements are applied to the first or second sheet of two-dimensional material to form a composite material and the composite material is then applied to the structural substrate.

In an aspect, a filtration membrane comprises a plurality of spacer elements disposed between a sheet of perforated two-dimensional material and a supporting substrate. In an embodiment, the filtration membrane is prepared by a method comprising disposing a first plurality of spacer elements between a first sheet of perforated two-dimensional material and at least one of a surface of a structural substrate and a surface of a second sheet of perforated two-dimensional material. In an embodiment, the method further comprises providing a structural substrate on an alternate surface of the first or second sheet of perforated two-dimensional material.

In an aspect, a structure comprises a structural substrate having at least one relief feature at a surface of the structural substrate, and a first sheet of perforated two-dimensional material disposed upon the structural substrate such that the first sheet of perforated two-dimensional material substantially encloses the at least one relief feature. In an embodiment, the structure further comprises a plurality of spacer elements disposed upon the first sheet of perforated two-dimensional material and a second sheet of perforated two-dimensional material disposed upon the plurality of spacer elements such that the spacer elements are between the first and second sheets of two-dimensional material. In an embodiment, a plurality of spacer elements may be disposed within the at least one relief feature.

In an aspect, a method for forming a structure comprises providing a first sheet of a perforated two-dimensional material and a structural substrate, forming at least one relief feature at a surface of the structural substrate, and disposing the first sheet of perforated two-dimensional material upon the structural substrate. In embodiment, the width of the relief feature is less than 5 micrometers, or less than 2 micrometers, or from 100 nm to 500 nm, or from 25 nm to 100 nm, or from 5 to 25 nm. In an embodiment, the length of the relief feature is greater than the width of the relief feature, with the length being limited by the size of the sheets of two-dimensional material. In an embodiment, the density of relief features is from 1% to 30%. In an embodiment, the at least one relief feature may be formed by known chemical and/or mechanical etching techniques, including lithography techniques such as nanoimprint lithography, electron beam lithography and self assembly methods.

In an aspect, a filtration membrane to selectively separate components in a medium comprises at least two sheets of perforated two-dimensional material, each sheet having a plurality of selective pores and a plurality of non-selective pores, where the plurality of selective pores is sized to allow a specified component in the medium to pass therethrough and the plurality of non-selective pores allows the specified component and components larger than the specified component to pass therethrough, and where the plurality of selective pores and the plurality of non-selective pores are randomly distributed about each sheet of perforated two-dimensional material; and where the sheets of perforated two-dimensional material are positioned adjacent one another with the plurality of selective pores of one of the sheets of perforated two-dimensional material randomly aligned with respect to the plurality of selective pores of the adjacent sheet of perforated two-dimensional material and said plurality of non-selective pores are randomly aligned with respect to said plurality of non-selective pores of said adjacent sheet of perforated two-dimensional material. In an embodiment, said sheets of perforated two-dimensional material are positioned so as to provide flow paths only through aligned pores. In an embodiment, the filtration medium further comprises a supporting substrate having a surface in direct contact with at least one of the two sheets of perforated two-dimensional material. In an embodiment, the perforated two-dimensional materials are stacked so as to provide a selective flow path between the sheets of two-dimensional materials such that the size of the flow path contributes to component separation. For example, in an embodiment, the separation distance between the two-dimensional sheets is larger than an average effective diameter of one component (e.g., a desired component), but smaller than an average effective diameter of another component (e.g., an unwanted component). In this example, the unwanted component remains in the concentrate. However, in another embodiment, the smaller component may be the unwanted component and the larger component may be the desired component. In this example, the desired component remains in the concentrate. In an embodiment, the perforated two-dimensional materials are stacked so as to provide a non-selective flow path between said sheets of two-dimensional materials. The non-selective flow path is provided by a separation distance between the two-dimensional sheets that is larger than an average effective diameter of a desired component and an average effective diameter of an unwanted component.

In an embodiment, a filtration membrane further comprises a housing configured for reverse osmosis, nanofiltration, ultrafiltration, microfiltration, forward osmosis or pervaporative separation. For example, the housing may include an inlet, an outlet, one or more side walls and the like.

In an aspect, a filtration membrane comprises a plurality of spacer elements disposed between a sheet of perforated two-dimensional material and a supporting substrate. In an embodiment, the filtration membrane is prepared by a method comprising disposing a first plurality of spacer elements between a first sheet of perforated two-dimensional material and at least one of a surface of a structural substrate and a surface of a second sheet of perforated two-dimensional material. In an embodiment, the method further comprises providing a structural substrate on an alternate surface of the first or second sheet of perforated two-dimensional material.

All structures described herein may be made by one or more of the methods disclosed, and all methods disclosed herein may be used to make one or more the disclosed structures.

The foregoing has outlined the features of the present disclosure in order that the detailed description that follows can be better understood. Additional features and advantages of the disclosure will be described hereinafter. These and other advantages and features will become more apparent from the description below taken in conjunction with the drawings.

### BRIEF DESCRIPTION OF THE DRAWINGS

These and other features and advantages of the present invention will be better understood with reference to the following description, appended claims, and accompanying drawings, which are not drawn to scale.

FIG. 1 is a schematic of graphene, which may be a two-dimensional material of a structure disclosed herein.

FIG. 2 is a schematic of several exemplary structures according to the invention having spacer elements between sheets of perforated two-dimensional materials (A, C, D, E, F) and/or between a perforated two-dimensional material and a supporting substrate (B, E, F). In some embodiments, a structure may include two or more layers of spacer elements (E, F) and/or two or more perforated two-dimensional materials in direct contact with one another (D, F).

FIG. 3 is a schematic of a two-dimensional sheet with perforation induced pores, intrinsic defects, and processing defects, wherein any of these features can result in selective pores and non-selective pores depending on the components to be filtered from the medium, where most perforation-induced pores are selective and most defects are non-selective.

FIG. 4 is a schematic of a stack of two-dimensional materials.

FIG. 5 is a graph showing flow rate vs. rejection percentage of 50 nm gold nanoparticles through stacked single layer graphene sheets.

FIG. 6 is a graph showing flow rate vs. rejection percentage of 5 nm gold nanoparticles through stacked few layer graphene sheets.

FIG. 7 is a graph showing cumulative permeate volume vs. permeate flowrate on the left y-axis and sodium chloride rejection percentage on the right y-axis at pressures of (A) 50 psi or 150 psi and (B) 150 psi, 300 psi, 450 psi or 600 psi.

FIG. 8 is a series of high resolution images showing a stack of two single layers of graphene demonstrating sodium chloride rejection.

FIG. 9 is a cross-sectional schematic of a structure comprising a plurality of two-dimensional membranes on a structural substrate.

FIG. 10 is a cross-sectional schematic of a structure comprising a plurality of two-dimensional membranes disposed on a structural substrate, where the two-dimensional membranes are separated by a plurality of spacer elements.

FIG. 11 is a schematic of a stack of two-dimensional materials where high non-selective pore density and low selective pore density are employed in accordance with an embodiment of the present invention.

FIG. 12 is a schematic of a stack of two-dimensional materials where low non-selective pore density is employed in accordance with an embodiment of the present invention.

FIG. 13 is a schematic showing the misalignment of holes in a graphene layer to the holes in a structural substrate.

FIG. 14 is a schematic showing a structure comprising graphene disposed on a layer of carbon nanostructures dispersed on a surface of a structural substrate.

FIG. 15 is a schematic showing how carbon nanotubes or other material can be used to unblock the pores of perforated graphene, or another two-dimensional material, and provide flow channels.

FIG. 16 is a schematic showing illustrative depictions of carbon nanotubes that are (A) branched, (B) crosslinked and/or (C) share walls.

FIG. 17 is a schematic showing an illustrative depiction of a carbon nanostructure flake material having dimensions (1, w or h) after isolation of the material from a growth substrate.

FIG. 18 shows illustrative SEM images at 5 μm resolution of the shiny side (A) having carbon nanostructures deposited thereon and the dull side (B) (without CNSs) of a TEPC substrate having a thickness of 20 μm and a pore size of 100 nm.

FIG. 19 is a schematic showing illustrative SEM images at 20 μm (A) and 5 μm (B) resolution of unmodified carbon nanostructures that have been deposited on TEPC.

FIG. 20 is a schematic showing illustrative SEM images at 20 μm (A) and 5 μm (B) resolution of carbon nanostructures that have been deposited on TEPC from a 2:1 solution.

FIG. 21 is a schematic showing illustrative SEM images at 20 μm (A) and 5 μm (B) resolution of carbon nanostructures that have been deposited on TEPC from a 5:1 solution.

FIG. 22 is a schematic showing how fabricated relief features in the surface of a supporting substrate can be used to unblock the pores of perforated graphene, or another two-dimensional material, and provide flow channels for a permeate.

FIG. 23 is a schematic showing the effect of unblocking pores using the relief features of FIG. 22 relative to a structure having blocked pores, such as the structure shown in FIG. 13.

### DETAILED DESCRIPTION

Designs for improving the permeability of structures comprising perforated two-dimensional materials and porous supporting substrates are disclosed. The disclosed structures implement stacking of individual atomically thin sheets of two-dimensional materials to increase flow (e.g., lateral flow) within the structures and to reduce the impact of defects within a single sheet. In some embodiments, the use of multiple sheets of material improves selectivity and mechanical performance without significantly reducing permeability. Many of the disclosed structures contain graphene, graphene-based or other two-dimensional materials supported upon a layer of spacer elements.

Graphene has garnered widespread interest for use in a number of applications due to its favorable mechanical and electronic properties. Applications that have been proposed for graphene include, for example, optical devices, mechanical structures, and electronic devices. In addition to the foregoing applications, there has been some interest in perforated graphene and other two-dimensional materials for filtration or separation applications, where the perforated materials can offer permeability values that are orders of magnitude higher than existing membranes in areas such as desalination or molecular filtration processes. In filtration and separation applications, the perforated graphene can be applied to a substrate providing structural substrate of a specific porosity and permeability for the given application, while also providing a smooth, suitable interface for high quality graphene coverage. Otherwise, the surface morphology of the structural substrate can damage the graphene and limit the types of substrates suitable for use. In some instances, a surface roughness of about 50 nm or less may be needed to avoid damaging the graphene or other two-dimensional material.

Graphene-based materials include, but are not limited to, single layer graphene, multilayer graphene or interconnected single or multilayer graphene domains and combinations thereof. In embodiments, multilayer graphene includes 2 to 20 layers, 2 to 10 layers or 2 to 5 layers. In embodiments, graphene is the dominant material in a graphene-based material. For example, a graphene-based material comprises at least 30% graphene, or at least 40% graphene, or at least 50% graphene, or at least 60% graphene, or at least 70% graphene, or at least 80% graphene, or at least 90% graphene, or at least 95% graphene. In embodiments, a graphene-based material comprises a range of graphene selected from 30% to 95%, or from 40% to 80% or from 50% to 70%.

As used herein, a “domain” refers to a region of a material where atoms are uniformly ordered into a crystal lattice. A domain is uniform within its boundaries, but different from a neighboring region. For example, a single crystalline material has a single domain of ordered atoms. In an embodiment, at least some of the graphene domains are nanocrystals, having domain sizes from 1 to 100 nm or 10 to 100 nm. In an embodiment, at least some of the graphene domains have a domain size greater than 100 nm up to 100 microns, or from 200 nm to 10 microns, or from 500 nm to 1 micron. “Grain boundaries” formed by crystallographic defects at edges of each domain differentiate between neighboring crystal lattices. In some embodiments, a first crystal lattice may be rotated relative to a neighboring second crystal lattice, by rotation about an axis perpendicular to the plane of a sheet, such that the two lattices differ in “crystal lattice orientation”.

In an embodiment, the sheet of graphene-based material comprises a sheet of single or multilayer graphene or a combination thereof. In an embodiment, the sheet of graphene-based material is a sheet of single or multilayer graphene or a combination thereof. In another embodiment, the sheet of graphene-based material is a sheet comprising a plurality of interconnected single or multilayer graphene domains. In an embodiment, the interconnected domains are covalently bonded together to form the sheet. When the domains in a sheet differ in crystal lattice orientation, the sheet is polycrystalline.

In embodiments, the thickness of the sheet of graphene-based material is from 0.34 to 10 nm, from 0.34 to 5 nm, or from 0.34 to 3 nm, or from 0.5 to 2 nm. A sheet of graphene-based material may comprise intrinsic defects. Intrinsic defects are those resulting unintentionally from preparation of the graphene-based material in contrast to perforations which are selectively introduced into a sheet of graphene-based material or a sheet of graphene. Such intrinsic defects include, but are not limited to, lattice anomalies, pores, tears, cracks or wrinkles. Lattice anomalies can include, but are not limited to, carbon rings with other than 6 members (e.g. 5, 7 or 9 membered rings), vacancies, interstitial defects (including incorporation of non-carbon atoms in the lattice), and grain boundaries.

In an embodiment, the layer comprising the sheet of graphene-based material further comprises non-graphenic carbon-based material located on the a surface of the sheet of graphene-based material. In an embodiment, the non-graphenic carbon-based material does not possess long-range order and may be classified as amorphous. In embodiments, the non-graphenic carbon-based material further comprises elements other than carbon and/or hydrocarbons. Non-carbon materials which may be incorporated in the non-graphenic carbon-based material include, but are not limited to, hydrogen, hydrocarbons, oxygen, silicon, copper and iron. In embodiments, carbon is the dominant material in non-graphenic carbon-based material. For example, a non-graphenic carbon-based material comprises at least 30% carbon, or at least 40% carbon, or at least 50% carbon, or at least 60% carbon, or at least 70% carbon, or at least 80% carbon, or at least 90% carbon, or at least 95% carbon. In embodiments, a non-graphenic carbon-based material comprises a range of carbon selected from 30% to 95%, or from 40% to 80%, or from 50% to 70%.

In an embodiment, a two-dimensional material suitable for the present structures and methods can be any substance having an extended planar molecular structure and an atomic level thickness. Particular examples of two-dimensional materials include graphene films, graphene-based material, transition metal dichalcogenides, metal oxides, metal hydroxides, graphene oxide, α-boron nitride, silicone, germanene, MXenes or other materials having a like planar structure. Specific examples of transition metal dichalcogenides include molybdenum disulfide and niobium diselenide. Specific examples of metal oxides include vanadium pentoxide. Graphene or graphene-based films according to the embodiments of the present disclosure can include single-layer or multi-layer films, or any combination thereof. Choice of a suitable two-dimensional material can be determined by a number of factors, including the chemical and physical environment into which the graphene, graphene-based material or other two-dimensional material is to be terminally deployed, ease of perforating the two-dimensional material, and the like.

Techniques used for introducing a plurality of pores into the graphene or graphene-based film or other two-dimensional material is not considered to be particularly limited and can include various chemical and physical perforation techniques. Suitable perforation techniques can include, for example, particle bombardment, chemical oxidation, lithographic patterning, electron beam irradiation, doping via chemical vapor deposition or any combination thereof. In some or other embodiments, a perforation process can be applied to the graphene or graphene-based film or other two-dimensional material before depositing spacer elements thereon. In some embodiments, a perforation process can be applied to the graphene or graphene-based film or other two-dimensional material after spacer elements are deposited thereon. In some embodiments, pores can be introduced in the graphene, graphene-based material or other two-dimensional material while it is adhered to its growth substrate. In still other embodiments, the graphene or graphene-based film or other two-dimensional material can be perforated after releasing the graphene or graphene-based film or other two-dimensional material from its growth substrate, such as through etching of the growth substrate.

In some embodiments, the structures described herein can be used for performing a filtration operation. The filtration operation can include ultrafiltration, microfiltration, nanofiltration, molecular filtration, reverse osmosis, forward osmosis, pervaporative separation or any combination thereof. The material being filtered by the perforated graphene, graphene-based or other two-dimensional material can constitute any material (solid, liquid or gas) that allows the desired filtrate to pass through the pores within the perforated two-dimensional material while retaining the concentrate material on an opposite side of the two-dimensional material. Materials that can be filtered using two-dimensional materials comprising nanometer or subnanometer-sized pores include, for example, ions, small molecules, viruses, proteins, and the like. In some embodiments, the perforated two-dimensional material described herein can be used in water desalination, gas-phase separation or water purification applications.

The terms “directly” and “indirectly” describe the actions or physical positions of one component relative to another component. For example, a component that “directly” acts upon or touches another component does so without intervention from an intermediary. Contrarily, a component that “indirectly” acts upon or touches another component does so through an intermediary (e.g., a third component).

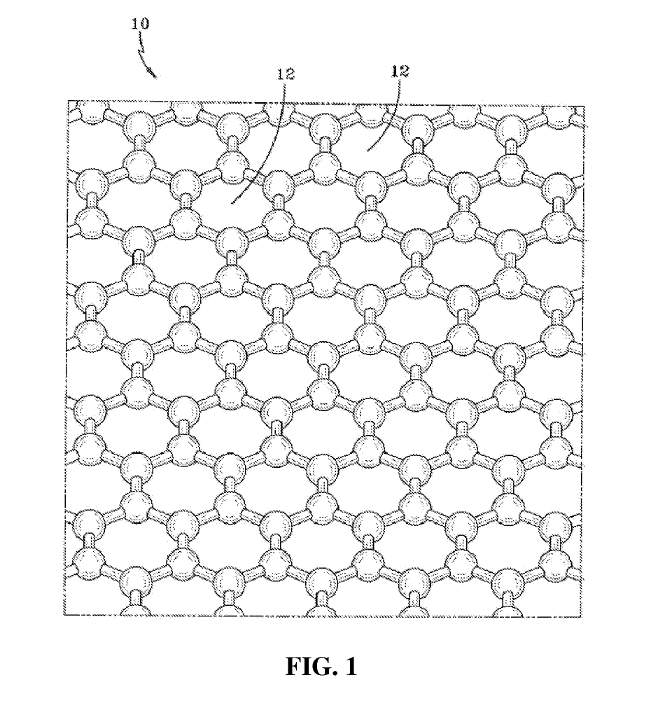

FIG. 1 shows a graphene sheet 10 of carbon atoms defining a repeating pattern of hexagonal ring structures that collectively form a two-dimensional honeycomb lattice. An interstitial aperture 12 of less than 1 nm in diameter is formed by each hexagonal ring structure in the sheet. More particularly, the interstitial aperture in a perfect crystalline graphene lattice is estimated to be about 0.23 nanometers across its longest dimension. Accordingly, graphene materials preclude transport of any molecule across the graphene sheet's thickness unless there are pores, perforation-induced or intrinsic. The thickness of a theoretically perfect single graphene sheet is approximately 0.3 nm. Further, graphene has a breaking strength about 200 times that of steel, a spring constant in the range 1 N/m to 5 N/m and a Young's modulus of about 0.5 TPa. Thinness and strength benefit filtration applications, where increased thinness prevents clogging of the membrane thickness and strength enables operation at higher pressures. The surface properties of graphene can also be utilized to reduce fouling effects, and functionalization of the graphene sheet or pores in the graphene can be used to further improve desired characteristics.

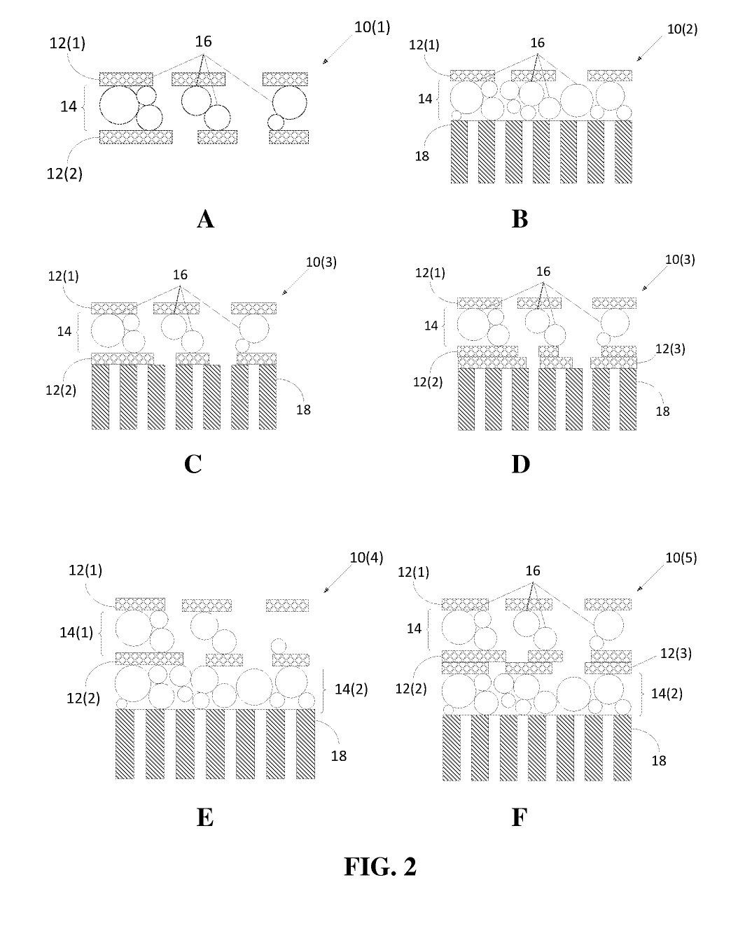

FIG. 2 is a schematic of several exemplary structures 10 according to the invention. In some embodiments, structures 10 comprise a layer 14 of spacer elements 16 between sheets of perforated two-dimensional materials 12. See, for example, FIGS. 2A, C, D, E and F. In some embodiments, structures 10 comprise a layer 14 of spacer elements 16 disposed between a perforated two-dimensional material 12 and a supporting substrate 18. See, for example, FIGS. 2B, E and F. In some embodiments, a structure 10 includes two or more layers 14(1) and 14(2) of spacer elements 16. See, for example, FIGS. 2E and F. In some embodiments, a structure 10 includes two or more perforated two-dimensional materials 12 in direct contact with one another. See, for example, FIGS. 2D and F.

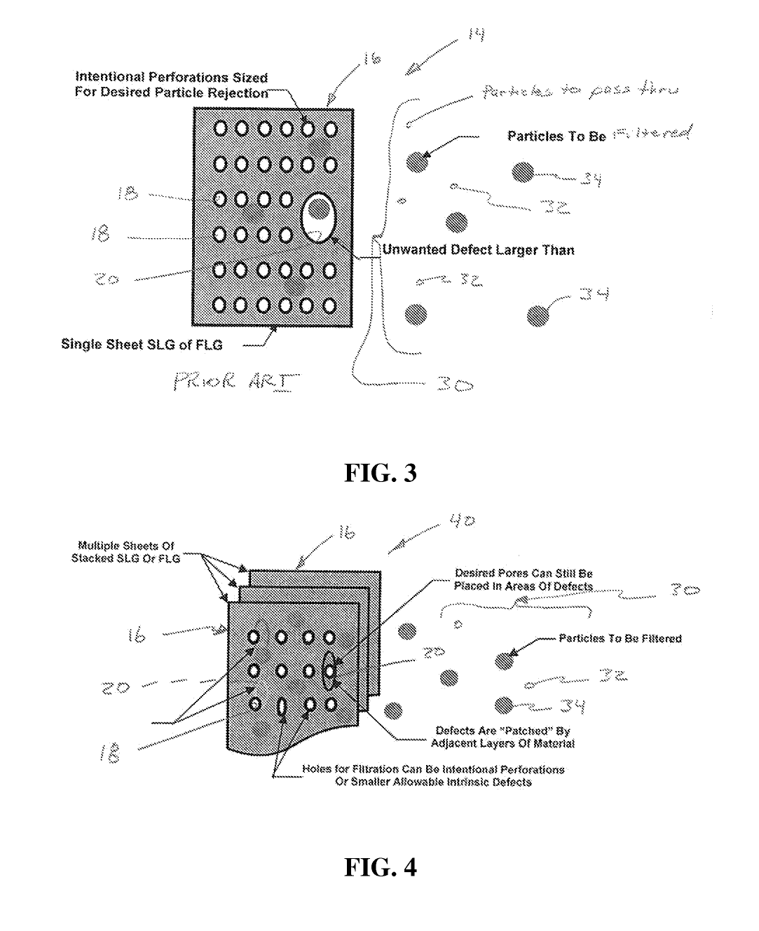

FIG. 3 illustrates a prior art filtration membrane 14 comprising a single atomically thin, two-dimensional sheet 16. Sheet 16 is provided with a plurality of pores 18, 20 which may be formed by any means known to those skilled in the art. In one embodiment, sheet 16 is provided with a plurality of pores of selective size 18. These may also be referred to as perforation-induced pores. The number and spacing of the perforation-induced pores may be controlled as needed. Pores 18 are intentionally formed and selected to be of a predetermined size so as to allow the passage of certain components while precluding the passage of components larger than the pore size. Such pores may be referred to as “selective pores.” Functionalization of the pore or surface of the sheet, or potentially application of electric charge, may be used to further influence selectivity through the pore. A plurality of defect pores 20 may also be formed in or intrinsic to sheet 16. Defect pores 20 may also be referred to as “non-selective pores”. Non-selective pores 20 are generally sized much larger than selective pores 18 and are randomly distributed about sheet 16. Non-selective pores 20 can be any pores that do not perform the desired separation or filtration operation. In use, a fluidic medium 30 may be applied to sheet 16 for filtration purposes. Medium 30, which may be a gas or liquid, including desired components 32, which are of a known size, and unwanted components 34, which are larger than desired components 32. As shown, unwanted components 34 are able to pass through non-selective pore 20, thereby reducing the rejection efficacy of membrane 14.

Referring now to FIG. 4, it can be seen that multiple two-dimensional sheets 16 are stacked upon one another to form a membrane 40. In one embodiment, sheets 16 may be stacked in contact with one another. In another embodiment, sheets 16 may have intermediate layers, such as a layer of spacer elements or a partial layer of two-dimensional material, disposed between them such that the sheets are in indirect contact. In yet another embodiment, a structure may include combinations of sheets in direct contact with one another and sheets in indirect contact with one another. In all of these embodiments, when medium 30 is applied to membrane 40 components 32, which are sized smaller than pores 18, pass through membrane 40. Unwanted components 34, which are sized larger than pores 18, may pass through a non-selective pore 20 of one of the sheets 16. However, the ability of the unwanted component 34 to pass through a second and/or a third sheet 16 is significantly reduced as a matter of statistical probability. Thus, membrane 40, which may include a porous supporting substrate, allows passage of components 32 while blocking a significant number, if not all, of unwanted components 34. In some embodiments, pores 18 and 20 are randomly aligned or intentionally misaligned so that the likelihood of unwanted components 34 flowing through membrane 40 is significantly reduced.

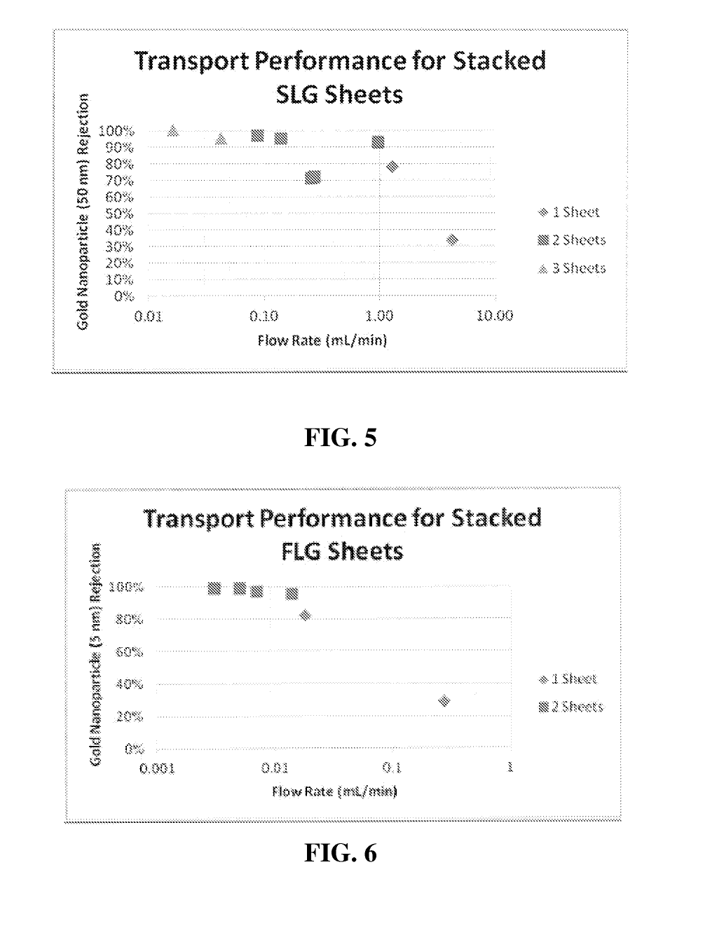

High resolution imaging and diffusive and convective fluid testing have been used to evaluate the characteristics of 1, 2 and 3 sheet graphene stacks. As shown in FIG. 5, 50 nm gold particles carried in a water medium are rejected to a different extent based on the number of graphene sheets in the stack. The graphene sheets were prepared by chemical vapor deposition and perforated by ion bombardment. Selective pores in each sheet were expected to be approximately 1 nm in effective diameter. An increase in 50 nm gold nanoparticle rejection with corresponding reduction in flow rate for an increasing number of single layer graphene sheets was demonstrated.

As shown in FIG. 6, 5 nm gold nanoparticles carried in a water medium were rejected to a different extent based based on the number of few-layer graphene sheets in the stack. The sheets were prepared by chemical vapor deposition and perforated by ion bombardment. Selective pores in each sheet were expected to be approximately 1 nm in effective diameter. An increase in 5 nm gold nanoparticle rejection with a corresponding reduction in flow rate for increasing number of few-layer graphene sheets was demonstrated.

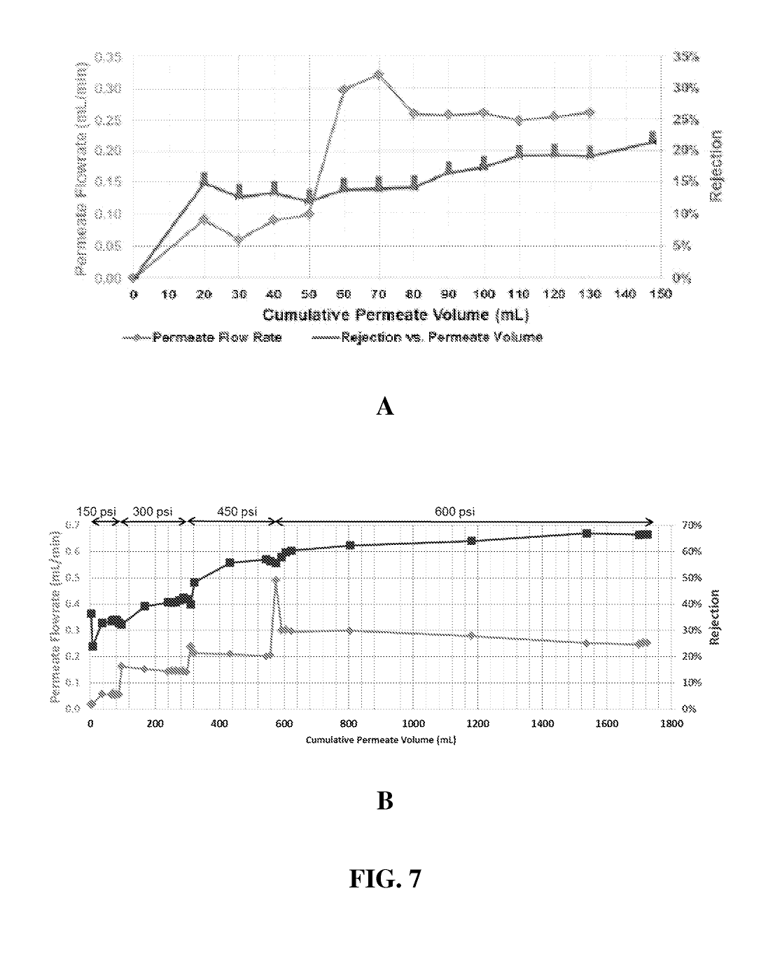

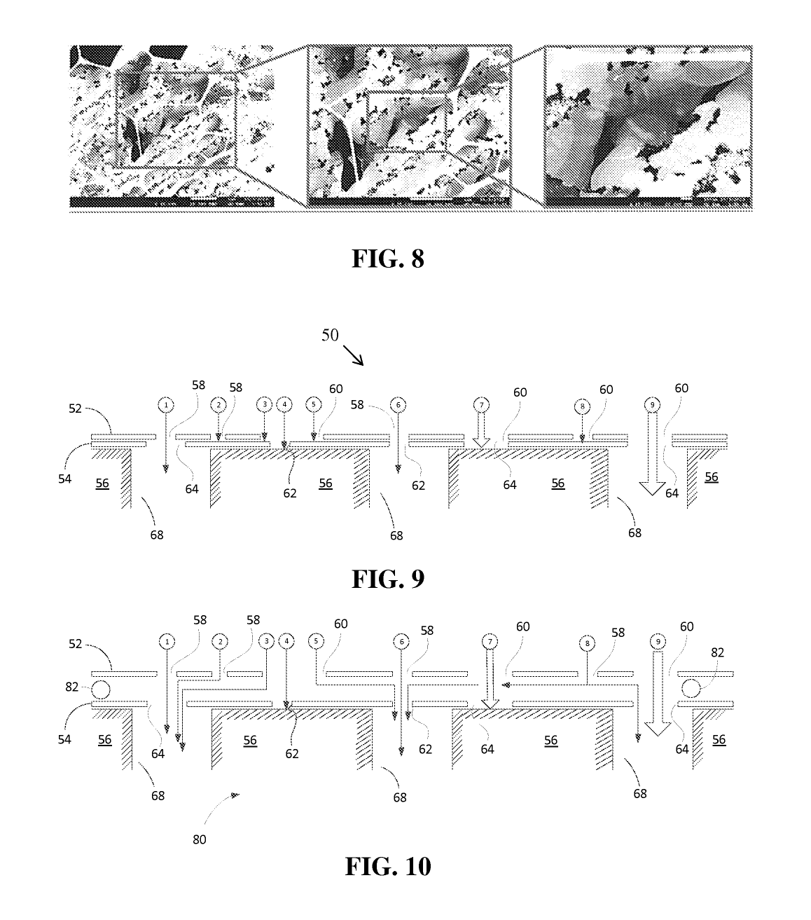

As shown in FIG. 7, sodium chloride rejection of up to 67% for a two sheet stack of single layer graphene was achieved. The sheets were prepared by carbon vapor deposition and perforated by ion bombardment. Selective pores in each sheet were expected to be approximately 1 nm in effective diameter. The operating pressure was 50 psi for the first 50 mL of permeate collected, then 150 psi for the remainder of the test in graph A. A commensurate increase in flow rate can be observed. In graph B, the operating pressure was 150 psi, 300 psi, 450 psi or 600 psi. FIG. 8 shows a high resolution image (SEM in transmission mode) of a single sheet from the two sheet single layer graphene stack used to demonstrate sodium chloride rejection. A combination of selective and non-selective perforation-induced pores, and intrinsic defects, can be seen.

FIG. 9 shows one embodiment of a structure 50 comprising stacked two-dimensional materials 52, 54, where adjacent sheets of the two-dimensional materials 52 and 54 are supported by a porous supporting substrate 56. As shown, sheets 52 and 54 are in direct contact or very closely spaced, thereby precluding the flow of the medium between the sheets. Further, sheet 52 has selective pores 58 and non-selective pores 60, while sheet 54 has selective pores 62 and non-selective pores 64. Porous supporting substrate 56 has openings 68 that may be aligned, partially aligned or not aligned with pores 58, 60, 62 and/or 64. This embodiment can be utilized where there is a high density of non-selective pores and a low density of selective pores such that it is desirable to mitigate the loss of selectivity for the overall structure. In FIG. 9, paths 2, 3, 4, 5, 7 and 8 are blocked, either by an adjacent sheet or the porous supporting substrate, while paths 1, 6 and 9 are open to the passage of selected components through pores 58 and 62 and substrate openings or pores 68.

FIG. 10 shows an embodiment of a structure 80 comprising stacked two-dimensional materials 52, 54, where sheets of the two-dimensional materials 52, 54 are separated by spacer elements 82 disposed between the sheets. For example, spacer elements 82 may be nanoparticles, nanostructures, CNTs, or similar structures. The size and distribution of spacer elements 82 can be used to control the spacing or average distance between the sheets of two-dimensional materials.

In one embodiment, the space between sheets of two-dimensional materials 52, 54 is too small to allow unwanted components to permeate or flow through the space. As a result, all vertical and lateral flow paths are open to components sized smaller than selective pores 58 and 62 and smaller than the separation distance between the two-dimensional materials. However, no components may pass through a pore that is adjacent to a surface of supporting substrate 56, rather than an opening 68, as evidenced by paths 4 and 7. But it is possible for an unwanted component to pass through the structure where non-selective pores 60, 64 in adjacent sheets are aligned with each other and with opening 68, as in path 9. This embodiment may be used to provide lateral flow of a medium between sheets, while increasing or maintaining selectivity against specific components in the medium. Such a configuration may be beneficial, for example, when the density of selective pores in a single sheet is small in comparison to the density of non-selective pores, as shown for example in FIG. 11. In FIG. 11, sheet 52 is in front of sheet 54 and the features in sheet 54 are shaded.

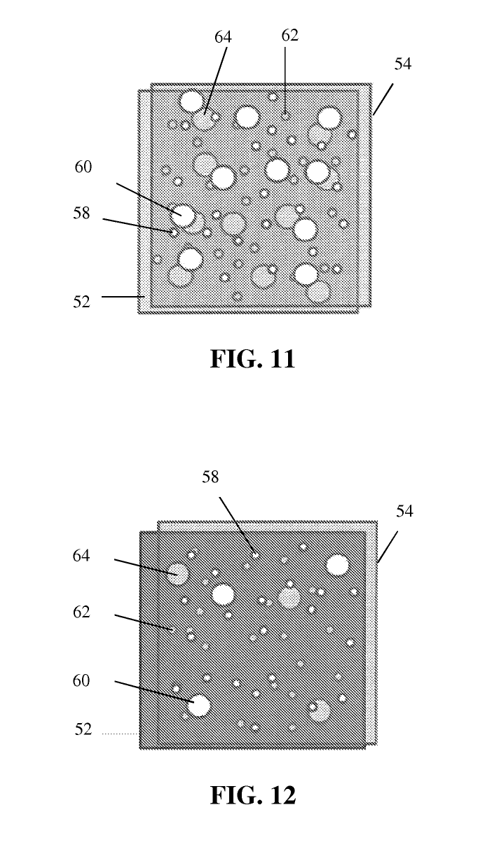

FIG. 10 also illustrates an embodiment where sheets of two-dimensional materials 52, 54 can be stacked to allow non-selective flow between the sheets. Such an embodiment may be implemented by providing a distance between neighboring two-dimensional sheets 52 and 54 that is greater than an effective diameter of most unwanted components. The distance between neighboring two-dimensional sheets may be controlled by appropriate selection of spacer element 82 size and distribution. All vertical and lateral flow paths are open to all components sized smaller than the separation distance between the two-dimensional materials. However, no components may pass through a pore that is adjacent to a surface of supporting substrate 56, rather than an opening 68, as evidenced by paths 4 and 7. In this embodiment, it is possible for an unwanted component to pass through the structure even where non-selective pores 60, 64 in adjacent sheets are misaligned with each other, so long as opening 68 is aligned with a non-selective pore, as in paths 3 and 9. This embodiment may be utilized when there is a high density of selective pores in a sheet such that there is a high likelihood of non-selective components that pass through a first sheet encountering a selective pore in a second sheet before encountering a non-selective pore in the second sheet. This type of configuration is shown, for example, in FIG. 12. In FIG. 12, sheet 52 is in front of sheet 54 and the features in sheet 54 are shaded.

The advantage of the embodiments shown in FIGS. 9 and 10 is that non-selective pores may exist, and contribute to overall permeability of the structure, without substantially degrading the selectivity of the structure. At least two sheets stacked on top of one another reduce or eliminate the impact of non-selective holes (e.g., tears) in a single sheet. By creating a filter structure including stacked sheets of two-dimensional materials, lesser quality sheets may be used to obtain comparable performance to a “perfect” single sheet. Non-selective defects will be covered or “patched” by an adjacent sheet of material, thereby reducing or eliminating the need to “repair” the material. In some embodiments, desired performance characteristics can be achieved by post processing the two-dimensional material(s) as individual or stacked sheets to achieve target perforation size.

In addition to reducing or eliminating the impact of non-selective pores in a single two-dimensional sheet via direct stacking of multiple two-dimensional sheets, structures disclosed herein may provide for indirect stacking of two-dimensional sheets to improve permeability and lateral flow within a structure and to expand the selection of useful supporting substrates by providing a layer of spacer elements upon a substrate surface that would otherwise be too rough to receive a two-dimensional material.

A variety of methods may be used for incorporation of spacer elements into the disclosed structures. Structures such as nanoparticles, nanotubes and flakes may be deposited from a solution, such as an aqueous solution, by casting, spraying or spin coating. Stochastic bombardment may be used to deposit nanoparticles or fullerenes. Spacers may also be made by applying a thin film and then ripening to form particles. Spacers in the form of partial layers may be made lithographically and patterned to desired dimensions. Such partial layers may be patterned on a separate substrate and then transferred to active layers (e.g., two-dimensional sheets) to act as spacer elements. In a further embodiment, exfoliation of a three-dimensional structure can be used to exfoliate and separate materials until a desired thickness for a spacer element is reached.

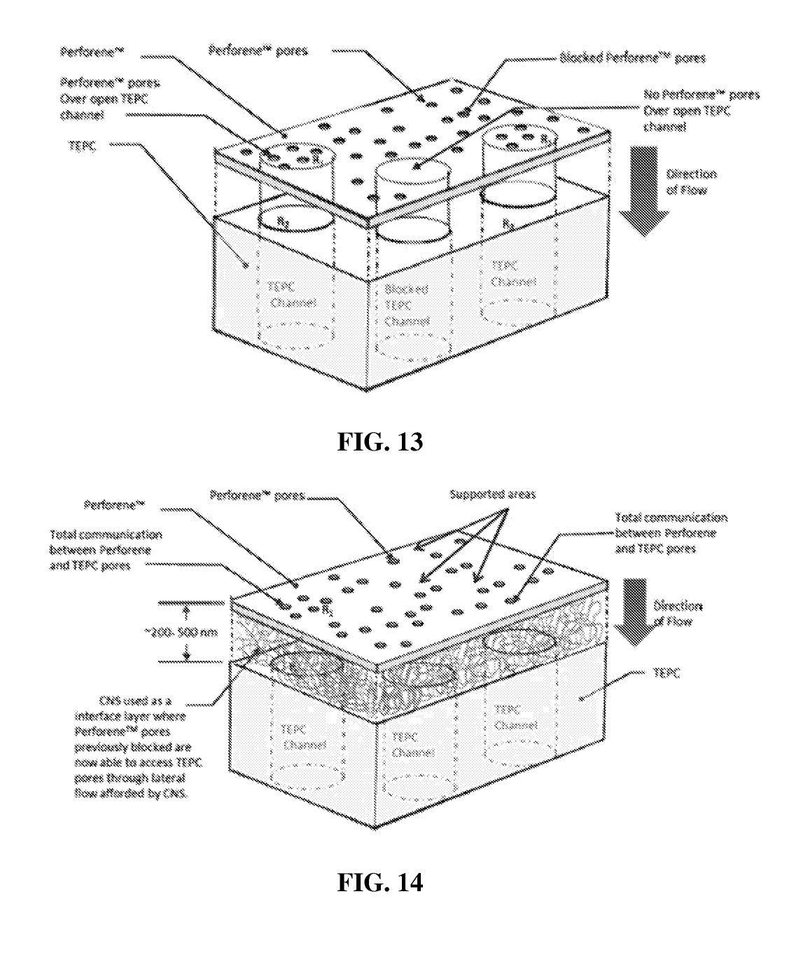

To date, substrate selections have typically been limited to very smooth materials such as track-etched polycarbonate (TEPC) that have very defined, cylindrical pores. Although this approach can result in adequate support of the graphene or other two-dimensional material, it can result in a less effective use of the holes in both the two-dimensional material and the structural substrate, as demonstrated in FIG. 13, which shows the misalignment of holes in a graphene layer to the holes in a structural substrate. As used in the drawings, the term PERFORENE™, a product of Lockheed Martin Corporation, will be used to refer to a perforated graphene or graphene-based material, although it is to be recognized that other two-dimensional materials can be used in a similar manner. The foregoing scenario can result in a very low active filtration percentage. For example, with 3% porosity in the two-dimensional materials and 5% porosity in the structural substrate, the highest active filtration percentage could be only ˜0.15% effective porosity, even with total alignment of the pores. That is, the active filtration percentage is multiplicative. Because there are areas that are blocked, the reality is that the active filtration percentage is significantly lower than theoretically possible.

The structures disclosed herein have a laterally permeable layer between the structural substrate and the graphene, graphene-based or other two-dimensional material to increase the effective porosity of the structure without significantly impacting the stability of the structure or damaging the two-dimensional material. For example, a layer of spacer elements, such as carbon nanostructures (CNS) or carbon nanotube-based material, may be disposed between the perforated graphene layer and its structural substrate to increase porosity in the form of increased lateral flow to previously blocked pores. FIG. 14 shows an illustrative schematic of a structure containing graphene disposed on a layer of spacer elements (e.g., carbon nanostructures) upon a structural substrate, where use of a layer of spacer elements allows for increased usage of the pores in both the two-dimensional layer and the structural substrate. As shown in FIG. 14, the previously blocked TEPC and graphene pores can now laterally access one another via the porosity of the carbon nanostructures in the layer of spacer elements. Moreover, in some cases, the structural substrate can be omitted altogether once the graphene or other two-dimensional material has been applied to the spacer elements. For example, the supporting substrate may be omitted when the spacer elements are carbon nanostructures. At the very least, the mechanical properties of the spacer elements (e.g., carbon nanotubes) can reinforce the structural substrate.

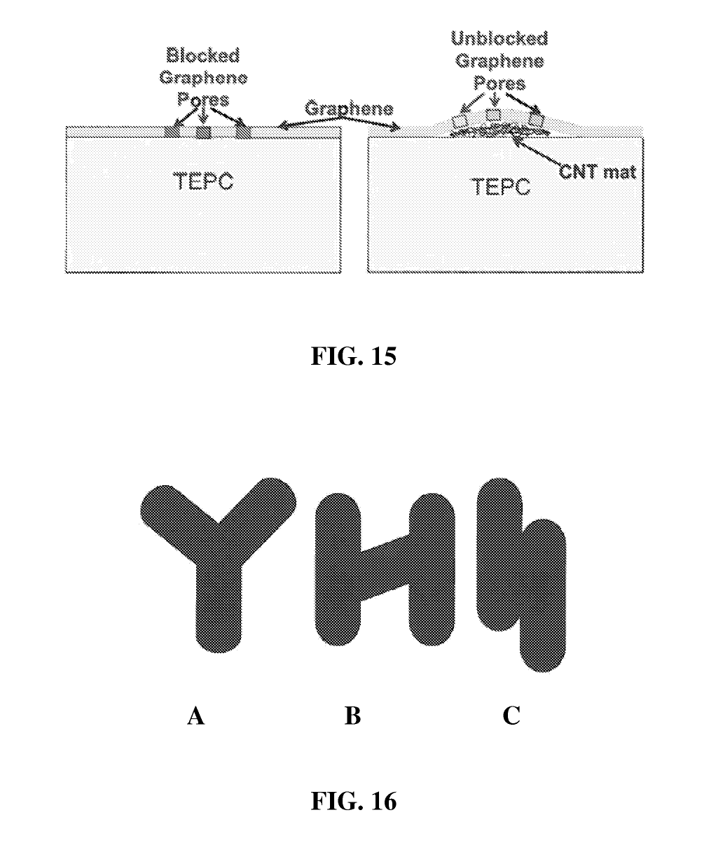

More generally, FIG. 15 shows how carbon nanotubes or other material can be used to unblock the pores in perforated graphene and other perforated two-dimensional materials, thereby increasing the ratio of selective pore summed area to non-selective pore summed area. Specifically, by “lifting” the perforated graphene or other two-dimensional material off the structural substrate, lateral flow along the substrate surface can be permitted, provided that there is sufficient room for a desired permeate to pass. Although carbon nano structures have been described herein as a spacer element that permits lateral flow to take place, it is to be recognized that alternative materials may also be used. Other illustrative materials permitting lateral flow to take place include, for example, carbon nanotubes and electro spun fibers.

In addition, the use of carbon nanostructures (CNSs) can allow structural substrates with lower porosity to be utilized, since there is essentially no “multiplicative” reduction in effective porosity from inefficient use of the holes in both the graphene, graphene-based or other two-dimensional material and the structural substrate. Conversely, when unwanted defects in the graphene or other two-dimensional material are present, their effects can be minimized due to the lower permeability of the structural substrate. Further, the use of spacer elements without an additional structural support or with a high permeability support can increase the ratio of selective pore summed area to non-selective pore summed area, thereby yielding a higher rejection of unwanted components. In addition, the spacer elements can also mitigate the effects of tears or other damage in the graphene or other two-dimensional material due to smaller unsupported spans.

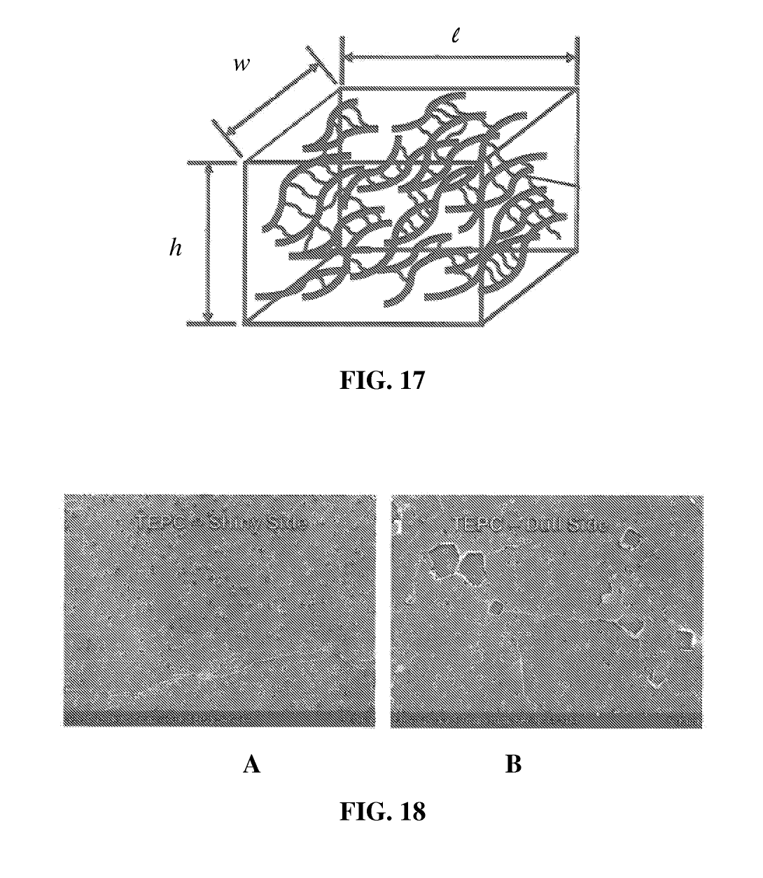

As used herein, the term “carbon nanostructure” refers to a plurality of carbon nanotubes that can exist as a polymeric structure by being interdigitated, branched, crosslinked, and/or by sharing common walls with one another. A carbon nanostructure can be considered to have a carbon nanotube as a base monomer unit of its polymeric structure. FIG. 16 shows illustrative depictions of carbon nanotubes that are branched (A), crosslinked (B) and/or share walls (C). Carbon nanostructures can be produced by growing carbon nanotubes on a fiber material and then removing the formed carbon nano structures therefrom in the form of a flake material, as described in U.S. patent application Ser. No. 14/035,856 (U.S. published application 2014/0093728), which is incorporated herein by reference in its entirety. FIG. 17 shows an illustrative depiction of a carbon nanostructure flake material after isolation of the carbon nanostructures from the growth substrate. In some embodiments, the carbon nanostructures can contain carbon nanotubes of about 10-20 nm in diameter and about a 30 nm pitch, leading to an effective average pore diameter of about 30 nm to about 50 nm in a range of about 10 nm to about 100 nm. Carbon nano structures are believed to differ structurally from carbon nanotubes that have been chemically crosslinked following synthesis of the carbon nanotubes. In alternative embodiments, carbon nanostructures that remain fused to the fiber material upon which they are grown can also be used as the spacer layer in the structures described herein.

Modified carbon nanostructures are believed to differ from unmodified carbon nanostructures in their ability to support graphene, graphene-based or other two-dimensional materials according to the embodiments described herein. In some embodiments, a thin layer of carbon nano structures is deposited on the surface of a structural substrate (e.g., from a liquid dispersion of carbon nanostructures), and the layer is allowed to dry. The carbon nanostructures or the layer formed therefrom can be chemically modified to be self-smoothing so that a conformal layer upon the structural substrate results, such that the carbon nano structure layer has sufficient surface smoothness for applying graphene or another two-dimensional material thereon. Mats of unmodified carbon nanostructures, in contrast, are not believed to form a conformal coating on the structural substrate with enough surface smoothness to effectively support the graphene or other two-dimensional material thereon. The chemical treatments to create a smooth CNS layer can involve thermal treatments in an oxidizing environment such as air, acid treatment, activation with strong alkaline solution or molten alkaline compounds, or plasma treatment. Additionally, surfactants (including anionic, cationic, nonionic and polar polymers, such as PVP and PVA in an aqueous solution) can also be employed to facilitate the dispersion of the CNS to form a smooth layer. In some embodiments, the layer of carbon nanostructures can have a thickness of about 1000 nm or less, particularly about 500 nm or less.

Because carbon nanostructures are composed of interwoven carbon nanotubes that are very similar in composition to graphene sheets, a layer of CNS spacer elements can be extremely strong while still behaving on the surface of the structural substrate much in the same way the graphene would. Moreover, the compositional similarity of carbon nanostructures to graphene can facilitate strong molecular interactions (e.g. pi-pi bonding, van der Waals forces, etc.) or other non-bonding carbon-carbon interactions between the carbon nanostructures and the graphene itself. Thus, by building up the surfaces of previously unusable structural substrates, such as nanofiber structural membranes, and rougher polymers such as nylon, PVDF and PES, gaps can be bridged upon the surface of the structural substrate with the CNS material (e.g., between the fibers or other rough surface) to provide a smooth interface for complaint graphene coverage while still retaining a high level of permeability. The CNS can furthermore promote adhesion of the graphene to an otherwise unsuitable substrate.

In addition, once the graphene or other two-dimensional material is placed on the carbon nano structures, the structural substrate may no longer be needed in order for effective structural support to be realized. The need to retain the structural substrate can depend on the operational pressure of the application in which the structure is deployed. Thus, in some embodiments, the carbon nanostructures can be applied to graphene on its copper growth substrate, and the growth substrate can then be removed (e.g., by etching the copper) to leave the graphene supported on the carbon nanostructures. This configuration can immensely improve the handling characteristics of the graphene or other two-dimensional material and reduce the occurrence of handling defects.

In some embodiments, deposition of carbon nanostructures onto the graphene or other two-dimensional material can take place via a spray deposition process of CNS onto the structural substrate or onto the graphene. A spray coating process can similarly be used for depositing the carbon nano structures onto the structural substrate.

Carbon nano structures are believed to be particularly suitable for supporting graphene and other two-dimensional materials due to the size of the carbon nanotubes therein. Because the carbon nanotubes are very small, the gaps between the carbon nanotubes are also small. This feature allows for the carbon nanostructures to retain extremely high permeability/porosity while adequately supporting the graphene or other two-dimensional material disposed upon it. Moreover, the application process being used results in self-leveling of the carbon nano structures onto the surface upon which it is being deposited. The chemically modified CNS can be floated down onto the surface of the structural substrate and a vacuum can be drawn to remove the solvent. Specific binders can be selected with respect to the underlying material in order to ensure a strong bond and preserve the desirable surface afforded after modification. In the case of TEPC, its surface is extremely smooth, and a conformal coating of the carbon nano structures likewise affords a smooth surface upon which the graphene or other two-dimensional material can be applied, thereby increasing accessibility to previous blocked TEPC pores.

Moreover, by practicing the embodiments described herein, a much wider breadth of structural substrates can be employed, including those that have higher surface non-uniformity than does TEPC. Moreover, TEPC can stretch and collapse under high pressure, which in turn can result in failure of the graphene or other two-dimensional material disposed thereon. It is now possible to consider stronger and previously too rough materials as structural substrates when using carbon nanostructures as an interface with the graphene or other two-dimensional material.

In addition to TEPC, other polymeric materials that can be used to form the structural substrate in the embodiments described herein include, for example, polyimides, polyethersulfones, polyvinylidene difluoride, and the like. The foregoing polymeric materials generally have smooth surfaces that are suitable for application of perforated graphene or other two-dimensional materials thereon, but they can be limited for the reasons discussed above. Other suitable polymeric materials, including those with rougher surfaces, will become evident to one having ordinary skill in the art and the benefit of this disclosure. Ceramic structural substrates can also be used in some embodiments.

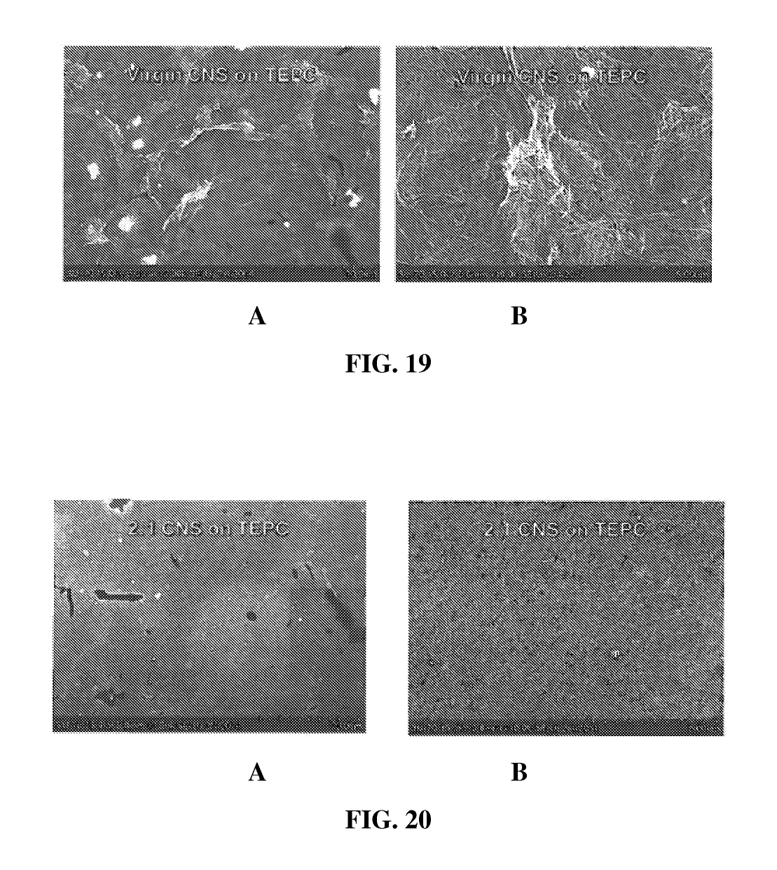

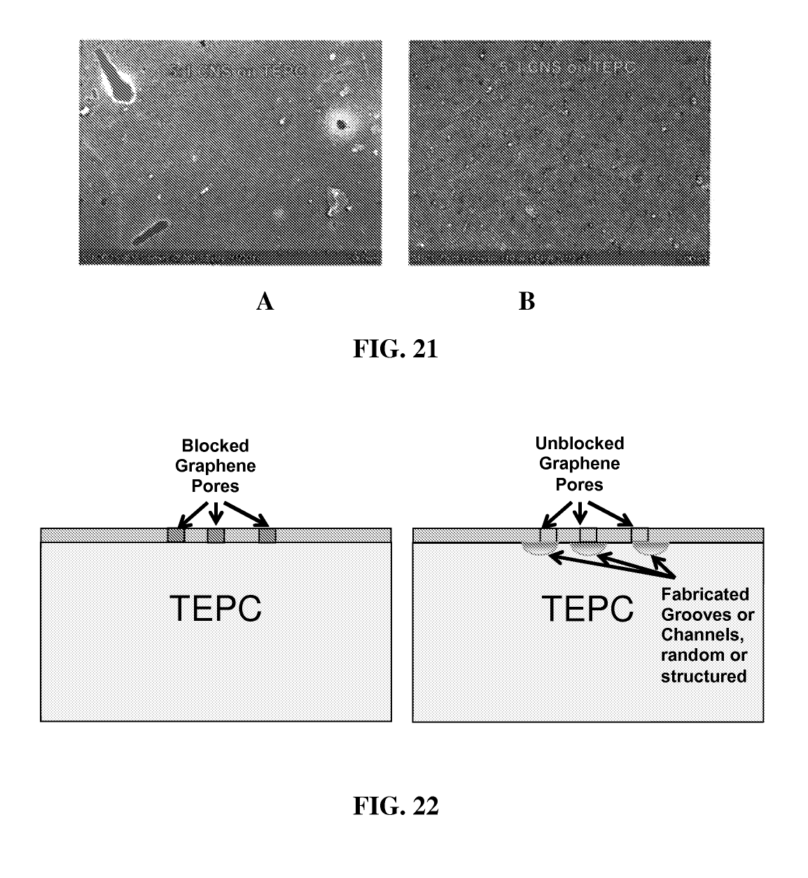

Studies utilizing carbon nanostructures to support a graphene layer have yielded encouraging results. FIG. 18 shows illustrative SEM images at 5 μm resolution of the shiny side (A) and dull side (B) of a TEPC substrate having a thickness of 20 μm and a pore size of 100 nm. In the embodiments described herein, the “shiny” side is the one that has the carbon nanostructures deposited thereon. FIG. 19 shows illustrative SEM images at 20 μm (A) and 5 μm resolution (B) of unmodified carbon nanostructures that have been deposited on TEPC. As shown in FIG. 19, the surface is very rough and unsuitable for support of graphene or another two-dimensional material thereon. FIG. 20 shows illustrative SEM images at 20 μm (A) and 5 μm resolution (B) of carbon nanostructures that have been deposited on TEPC from a 2:1 solution according to an embodiment. As shown in FIG. 20, a much smoother surface profile can be realized when utilizing the modified carbon nanostructures. FIG. 21 similarly shows illustrative SEM images at 20 μm (A) and 5 μm resolution (B) of carbon nanostructures that have been deposited on TEPC from a 5:1 solution according to an embodiment.

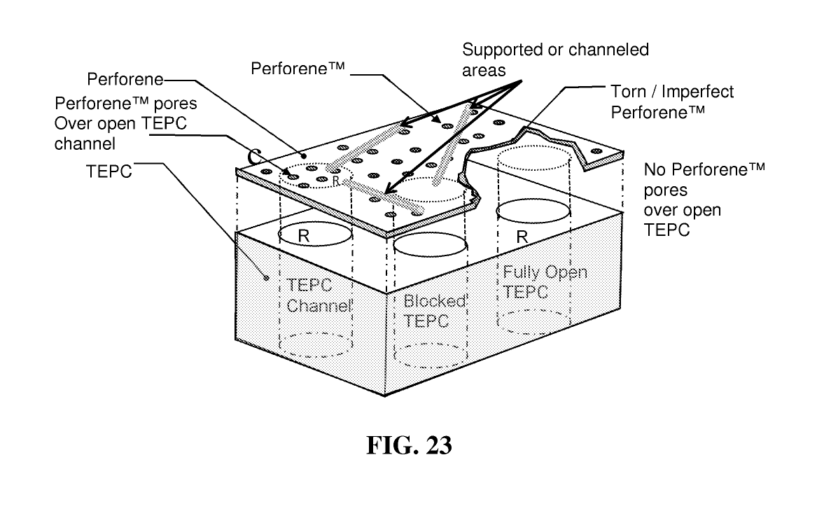

FIG. 22 is a schematic showing how relief features in the surface of a supporting substrate can be used to unblock the pores of perforated graphene, or another two-dimensional material, and provide flow channels for a permeate. As used herein, “relief features” may include random or ordered arrangements of grooves, channels, recesses, wells, troughs or the like. FIG. 23 is a schematic showing the effect of unblocking pores using the relief features of FIG. 22 relative to a structure having blocked pores, such as the structure shown in FIG. 13.

In various embodiments, the structures described herein can be utilized in various filtration and separation applications for both liquids and gases. Illustrative operations can include, for example, reverse osmosis, nanofiltration, ultrafiltration, microfiltration, forward osmosis and pervaporation. The structures can be particularly suitable for oil and gas filtration operations due to their high thermal stability and chemical resistance.

Although the invention has been described with reference to the disclosed embodiments, those skilled in the art will readily appreciate that these are only illustrative of the invention. It should be understood that various modifications can be made without departing from the spirit of the invention. The invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

Every formulation or combination of components described or exemplified can be used to practice the invention, unless otherwise stated. Specific names of compounds are intended to be exemplary, as it is known that one of ordinary skill in the art can name the same compounds differently. When a compound is described herein such that a particular isomer or enantiomer of the compound is not specified, for example, in a formula or in a chemical name, that description is intended to include each isomer and enantiomer of the compound described individually or in any combination. One of ordinary skill in the art will appreciate that methods, device elements, starting materials and synthetic methods other than those specifically exemplified can be employed in the practice of the invention without resort to undue experimentation. All art-known functional equivalents, of any such methods, device elements, starting materials and synthetic methods are intended to be included in this invention.

Whenever a range is given in the specification, for example, a temperature range, a time range, or a composition range, all intermediate ranges and subranges, as well as all individual values included in the ranges given are intended to be included in the disclosure. When a Markush group or other grouping is used herein, all individual members of the group and all combinations and subcombinations possible of the group are intended to be individually included in the disclosure.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements. The invention illustratively described herein suitably may be practiced in the absence of any element or elements, limitation or limitations which is not specifically disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

In general the terms and phrases used herein have their art-recognized meaning, which can be found by reference to standard texts, journal references and contexts known to those skilled in the art. The preceding definitions are provided to clarify their specific use in the context of the invention.

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

All patents and publications mentioned in the specification are indicative of the levels of skill of those skilled in the art to which the invention pertains. References cited herein are incorporated by reference herein in their entirety to indicate the state of the art, in some cases as of their filing date, and it is intended that this information can be employed herein, if needed, to exclude (for example, to disclaim) specific embodiments that are in the prior art. For example, when a compound is claimed, it should be understood that compounds known in the prior art, including certain compounds disclosed in the references disclosed herein (particularly in referenced patent documents), are not intended to be included in the claims.

1. A structure comprising a first sheet of perforated two-dimensional material and a first plurality of spacer elements disposed between a surface of said first sheet of perforated two-dimensional material and at least one of a surface of a structural substrate and a surface of a second sheet of perforated two-dimensional material.

2. The structure of claim 1, wherein said first plurality of spacer elements is disposed between said surface of said first sheet of perforated two-dimensional material and said surface of said second sheet of perforated two-dimensional material, said structure further comprising a structural substrate disposed on an alternate surface of the first or second sheet of perforated two-dimensional material.

3. The structure of claim 2, wherein said first plurality of spacer elements is disposed between said surface of said first sheet of perforated two-dimensional material and said surface of said second sheet of perforated two-dimensional material and a second plurality of spacer elements is disposed between said surface of said structural substrate and said alternate surface of said first or second sheet of perforated two-dimensional material.

4. The structure of claim 1 further comprising one or more additional sheets of perforated two-dimensional material in direct contact with said first and/or said second sheet of perforated two-dimensional material.

5. The structure of claim 1, wherein said first or second sheet of perforated two-dimensional material comprises a graphene or graphene-based film, a transition metal dichalcogenide, α-boron nitride, silicene, germanene, MXene or a combination thereof.

6. The structure of claim 1, wherein said first or second sheet of perforated two-dimensional material has an average pore size less than or equal to 4000 angstroms.

7. The structure of claim 1, wherein said first or second sheet of perforated two dimensional material comprises randomly distributed pores.

8. The structure of claim 1, wherein pores of said first or second sheet of perforated two-dimensional material are chemically functionalized at peripheries of the pores.

9. The structure of claim 1, wherein said spacer elements are randomly oriented and positioned.

10. The structure of claim 1, wherein a layer of said spacer elements has a thickness selected from a range of 5 angstroms to 10000 angstroms.

11. The structure of claim 1, wherein a layer of said spacer element has a substantially uniform thickness.

12. The structure of claim 1, wherein a layer of said spacer elements has a non-uniform thickness.

13. The structure of claim 1, wherein said spacer elements have average dimensions from 0.5 nm to 200 nm.

14. The structure of claim 1, wherein an average areal density of the spacer elements is from 2000 per μm² to 1 per μm².

15. The structure of claim 1, wherein the spacer elements adhere to the first and/or second sheet of perforated two-dimensional material.

16. The structure of claim 1, wherein said spacer elements comprise nanoparticles, nanotubes, nanofibers, nanorods, nanostructures or combinations thereof.

17. The structure of claim 1, wherein said spacer elements are selected from the group consisting of single walled carbon nanotubes, multiwalled carbon nanotubes, carbon nanostructures, fullerenes, carbon nanohorns and combinations thereof.

18. The structure of claim 1, wherein a layer of said spacer elements has an average surface roughness less than or equal to 50 nm.

19. The structure of claim 1, wherein the structural substrate comprises a porous polymer or a porous ceramic.

20. (canceled)

21. The structure of claim 1, wherein the structural substrate has a thickness between 1 μm to 500 μm.

22. The structure of claim 1, wherein the structural substrate has a porosity greater than or equal to 3%.

23. (canceled)

24. The structure of claim 1, wherein pores in the first or second sheet of perforated two-dimensional material are at least 10-fold smaller than pores in the structural substrate.

25. A method for forming a structure comprising:
disposing a first plurality of spacer elements between a first sheet of perforated two-dimensional material and at least one of a surface of a structural substrate and a surface of a second sheet of perforated two-dimensional material.

26. The method of claim 25, wherein said first plurality of spacer elements is disposed between said surface of said first sheet of perforated two-dimensional material and said surface of said second sheet of perforated two-dimensional material, said method further comprising:
providing a structural substrate on an alternate surface of the first or second sheet of perforated two-dimensional material.

27. The method of claim 25, wherein said first plurality of spacer elements is disposed between said surface of said first sheet of perforated two-dimensional material and said surface of said second sheet of perforated two-dimensional material, said method further comprising:
providing a second plurality of spacer elements on an alternate surface of the first or second sheet of perforated two-dimensional material; and
providing a structural substrate on said second plurality of spacer elements.

28. The method of claim 25, wherein
the spacer elements are applied to the structural substrate and the first or second sheet of perforated two-dimensional material is then applied to the spacer elements.

29. The method of claim 25, wherein the spacer elements are applied to the first or second sheet of two-dimensional material to form a composite material and the composite material is then applied to the structural substrate.

30. (canceled)

31. (canceled)

32. A filtration membrane comprising a plurality of spacer elements disposed between a sheet of perforated two-dimensional material and a supporting substrate, the filtration membrane prepared by the method of claim 30.

33. A structure comprising:
a structural substrate having at least one relief feature at a surface of the structural substrate; and a first sheet of perforated two-dimensional material disposed upon the structural substrate such that said first sheet of perforated two-dimensional material substantially encloses the at least one relief feature.

34. The structure of claim 33 further comprising a plurality of spacer elements disposed upon said first sheet of perforated two-dimensional material and a second sheet of perforated two-dimensional material disposed upon said plurality of spacer elements such that said spacer elements are between said first and second sheets of two-dimensional material.

35. A method for forming a structure comprising:
providing a first sheet of a perforated two-dimensional material and a structural substrate;
forming at least one relief feature at a surface of the structural substrate; and
disposing the first sheet of perforated two-dimensional material upon the structural substrate.

36. A filtration membrane to selectively separate components in a medium, comprising:
at least two sheets of perforated two-dimensional materials, each sheet having a plurality of selective pores and a plurality of non-selective pores,
wherein said plurality of selective pores are sized to allow a specified component in the medium to pass therethrough and said plurality of non-selective pores allow said specified component and components larger than said specified component to pass therethrough; and
wherein said plurality of selective pores and said plurality of non-selective pores are randomly distributed about each said sheet of perforated two-dimensional material; and
wherein said sheets of perforated two-dimensional materials are positioned adjacent one another with said plurality of selective pores of one of said sheets of perforated two-dimensional material randomly aligned with respect to said plurality of selective pores of said adjacent sheet of perforated two-dimensional material and said plurality of non-selective pores are randomly aligned with respect to said plurality of non-selective pores of said adjacent sheet of perforated two-dimensional material.

37. The filtration membrane according to claim 36, wherein said sheets of perforated two-dimensional material are positioned so as to provide flow paths only through aligned pores.

38. The filtration membrane according to claim 36, wherein said sheets of perforated two-dimensional material are positioned so as to provide a selective flow path in between said sheets.

39. The filtration membrane according to claim 36, wherein said sheets of perforate two-dimensional material are positioned so as to provide a non-selective flow path.

40. The filtration membrane according to claim 36 further comprising a housing configured for reverse osmosis, nanofiltration, ultrafiltration, microfiltration, forward osmosis or pervaporative separation.
